(19) United States
(12) Patent Application Publication
(10) Pub. No.: US 2023/0037003 A1
(43) Pub. Date: Feb. 2, 2023

(54) RE-WETTING TREATMENT OF DRY TAILINGS PRODUCED BY AN OIL SANDS SOLVENT EXTRACTION PROCESS

(71) Applicant: SUNCOR ENERGY INC., Calgary (CA)

(72) Inventors: Michael MARR, Calgary (CA); Tracy HOLMES, Mississauga (CA); Brian PITTENGER, Tyngsboro, MA (US); Shawn VAN DER MERWE, Calgary (CA)

(21) Appl. No.: 17/869,327

(22) Filed: Jul. 20, 2022

(30) Foreign Application Priority Data
Jul. 28, 2021 (CA) 3126255

(51) Int. Cl. B03B 9/02; C10G 1/04; B01D 11/02

(52) U.S. Cl. CPC B03B 9/02; C10G 1/045; B01D 11/0284

(57) ABSTRACT

Processes for conditioning a dry tailings material from a non-aqueous extraction (NAE) process for extracting bitumen from oil sands ore are described. The process can include contacting a main stream of the dry tailings material with a re-wetted tailings seed stream to produce a combined tailings material, and subjecting the combined tailings material to re-wetting to produce a re-wetted tailings material. The re-wetting can include adding a wetting agent to the combined tailings material, and imparting mixing to the combined tailings material. Contacting the main stream of the dry tailings material with the re-wetted tailings seed stream can include recycling a portion of the re-wetted tailings material to the main stream of the dry tailings material as the re-wetted tailings seed stream to produce the combined tailings material, or subjecting a sub-stream of the dry tailings material to sub-stream re-wetting to produce the re-wetted tailings seed stream.

### RELATED PATENT APPLICATION

This application claims priority from Canadian patent application No. 3,126,255, filed on Jul. 28, 2021, and titled “RE-WETTING TREATMENT OF DRY TAILINGS PRODUCED BY AN OIL SANDS SOLVENT EXTRACTION PROCESS”, the disclosure of which is hereby incorporated by reference in its entirety.

### TECHNICAL FIELD

The technical field generally relates to the processing of mined oil sands, and more particularly to the treatment of dry tailings produced by non-aqueous extraction techniques for extracting bitumen from mined oil sands.

### BACKGROUND

Conventional methods for extracting bitumen from oil sands rely on mixing the oil sands with water to form an aqueous slurry, and separating the aqueous slurry into fractions including bitumen froth and aqueous tailings. The bitumen froth is then treated to remove residual water and solids and produce a bitumen product, while the aqueous tailings are stored in tailings ponds and/or subjected to further processing. Water-based extraction methods have various challenges related to the production, handling and disposal of aqueous tailings materials.

Non-aqueous extraction (NAE) processes for extracting bitumen from oil sands have been developed to overcome some of the challenges associated with conventional aqueous extraction processes. NAE processes for producing a bitumen product from oil sands can provide advantages related to reduced water demand and reduced aqueous tailings production. Non-aqueous extraction of bitumen can be carried out using a low boiling point organic solvent that has a high solubility for bitumen and allows separation from the bitumen after extraction. The solid mineral materials from which bitumen is extracted can be washed, drained, and dried to form dry tailings, which can then be disposed of into a mine pit as reclamation material, thereby facilitating mine reclamation and reducing tailings management requirements.

However, there are several challenges associated with the handling of dry tailings produced by NAE processes. NAE dry tailings include fine clay and sand particles, typically have a very low moisture content and are hydrophobic. Such characteristics of the NAE dry tailings can contribute to dust generation, and reduce the suitability of the geotechnical properties for subsequent permanent storage. NAE dry tailings can also have a high temperature out of the drying process, which may drive the need for additional safety precautions for handling such hot material.

Therefore, various challenges exist in terms of technologies for handling dry tailings produced from NAE processes.

### SUMMARY

In accordance with an aspect, there is provided a process for conditioning a dry tailings material from a non-aqueous extraction (NAE) process for extracting bitumen from oil sands ore, the process comprising:
contacting a main stream of the dry tailings material with a re-wetted tailings seed stream to produce a combined tailings material; and
subjecting the combined tailings material to re-wetting to produce a re-wetted tailings material, comprising:
   adding a wetting agent to the combined tailings material; and
   imparting mixing to the combined tailings material.

In some implementations, contacting the main stream of the dry tailings material with the re-wetted tailings seed stream comprises:
recycling a portion of the re-wetted tailings material to the main stream of the dry tailings material as the re-wetted tailings seed stream to produce the combined tailings material.

In some implementations, subjecting the combined tailings material to re-wetting is performed in a re-wetting unit that comprises a rotary drum.

In some implementations, imparting mixing to the combined tailings material is performed prior to adding the wetting agent to the combined tailings material.

In some implementations, imparting mixing to the combined tailings material is performed in a rotary drum.

In some implementations, adding the wetting agent to the combined tailings material comprises supplying the wetting agent to the combined tailings material travelling onto a conveyor.

In some implementations, supplying the wetting agent to the combined tailings material travelling onto the conveyor comprises spraying the wetting agent onto the combined tailings material via an overhead spray.

In some implementations, contacting the main stream of the dry tailings material with the re-wetted tailings seed stream comprises:
subjecting a sub-stream of the dry tailings material to sub-stream re-wetting in a sub-stream re-wetting unit to produce the re-wetted tailings seed stream.

In some implementations, the sub-stream re-wetting unit comprises a rotating element comprising a shaft and projections extending outwardly therefrom.

In some implementations, the projections comprises baffles, blades and/or paddles configured to impart the mixing to the combined tailings material.

In some implementations, the rotating element is configured as an auger conveyor, and the projections are provided as an helicoidal projection extending around the shaft.

In some implementations, the sub-stream re-wetting unit comprises a pugmill.

In some implementations, imparting mixing to the combined tailings material is performed prior to adding the wetting agent to the combined tailings material.

In some implementations, imparting mixing to the combined tailings material is performed in a rotary drum.

In some implementations, adding the wetting agent to the combined tailings material comprises supplying the wetting agent to the combined tailings material travelling onto a conveyor.

In some implementations, supplying the wetting agent to the combined tailings material travelling onto the conveyor comprises spraying the wetting agent onto the combined tailings material via an overhead spray.

In some implementations, the process further comprises supplying the re-wetted tailings material to a conveyor and spraying an additional wetting agent onto the re-wetted tailings material.

In some implementations, the dry tailings material has a dry tailings moisture content of less than 3 wt %.

In some implementations, the dry tailings material has a dry tailings moisture content of less than 1 wt %.

In some implementations, the re-wetted tailings seed stream has a seed stream moisture content above 6 wt %.

In some implementations, the combined tailings material has a combined tailings moisture content above 2 wt %.

In some implementations, the combined tailings material has a combined tailings moisture content between 2 wt % and 4 wt %.

In some implementations, the combined tailings material has a combined tailings moisture content between 3 wt % and 15 wt %.

In some implementations, the combined tailings material has a combined tailings moisture content between 5 wt % and 12 wt %.

In some implementations, the combined tailings material has a combined tailings moisture content between 6 wt % and 10 wt %.

In some implementations, the combined tailings material has a combined tailings moisture content between 6 wt % and 15 wt %.

In some implementations, the combined tailings material has a combined tailings moisture that is between 2 to 10 times a dry tailings moisture content of the dry tailings material.

In some implementations, the combined tailings moisture content of the combined tailings material is equal to or above a predetermined combined tailings moisture content of the combined tailings material.

In some implementations, the predetermined combined tailings moisture content for the combined tailings material corresponds to a moisture content threshold above which the combined tailings material becomes hydrophilic.

In some implementations, the re-wetted tailings seed stream is provided at a weight ratio relative to the main stream of the dry tailings material that enables reaching the predetermined combined tailings moisture content for the combined tailings material.

In some implementations, the re-wetted tailings seed stream is provided at a weight ratio ranging between 1:1 to 1:6 relative to the main stream of the dry tailings material to produce the combined tailings material.

In some implementations, adding the wetting agent to the combined tailings material decreases a temperature of the re-wetted tailings material below 80° C.

In some implementations, the wetting agent comprises an aqueous wetting agent.

In some implementations, the aqueous wetting agent comprises water recovered from a NAE solids dryer.

In some implementations, the aqueous wetting agent comprises water recovered from a mine site.

In some implementations, the aqueous wetting agent comprises process-affected water from an oil sands mining facilities.

In some implementations, the aqueous wetting agent comprises mature fine tailings.

In some implementations, the aqueous wetting agent comprises fluid fine tailings.

In some implementations, the aqueous wetting agent comprises froth treatment tailings.

In some implementations, the wetting agent comprises a wetting agent additive.

In some implementations, the wetting agent additive comprises a non-ionic surfactant.

In some implementations, the wetting agent additive comprises an anionic surfactant.

In some implementations, the wetting agent comprises steam.

In some implementations, the re-wetted tailings material is suitable for deposition in a permanent storage area.

In accordance with another aspect, there is provided a process for conditioning a dry tailings material from a non-aqueous extraction (NAE) process for extracting bitumen from oil sands ore, the process comprising:
subjecting the dry tailings material to re-wetting to produce a re-wetted tailings material, comprising:
   adding a wetting agent to a main stream of the dry tailings material;
   imparting mixing to the main stream of the dry tailings material;
recycling a portion of the re-wetted tailings material to the dry tailings material; and
combining the re-wetted tailings material with the dry tailings material.

In accordance with another aspect, there is provided a process for conditioning a dry tailings material from a non-aqueous extraction (NAE) process for extracting bitumen from oil sands ore, the process comprising:
subjecting a sub-stream of the dry tailings material to re-wetting to produce a re-wetted sub-stream, comprising:
   combining the sub-stream of the dry tailings material with a sub-stream wetting agent;
combining the re-wetted sub-stream with a main stream of the dry tailings material to produce a combined tailings material;
subjecting the combined tailings material to re-wetting to produce a re-wetted tailings material, comprising:
   combining the combined tailings material with a main stream wetting agent.

In accordance with another aspect, there is provided a process for treating solvent diluted tailings from a non-aqueous extraction (NAE) process for extracting bitumen from oil sands ore, the process comprising:
subjecting the solvent diluted tailings to drying to produce a dry tailings material;
subjecting the dry tailings material to re-wetting, comprising:
   dividing the dry tailings material into a predetermined number of streams of dry tailings material; and
   subjecting each stream of the predetermined number of streams of dry tailings material to a corresponding re-wetting stage to produce a plurality of streams of re-wetted tailings material.

In accordance with another aspect, there is provided a process for treating solvent diluted tailings from a non-aqueous extraction (NAE) process for extracting bitumen from oil sands ore, the process comprising:
subjecting the solvent diluted tailings to drying, comprising:
   dividing the solvent diluted tailings into a predetermined number of streams of solvent diluted tailings;
   subjecting each stream of the predetermined number of streams of solvent diluted tailings to a corresponding drying stage to produce a predetermined number of streams of dry tailings material;
subjecting each stream of the predetermined number of streams of dry tailings material to a corresponding re-wetting stage to produce a plurality of streams of re-wetted tailings material.

In some implementations, the predetermined number of streams of dry tailings material is determined according to a volume of the dry tailings material to be subjected to the corresponding re-wetting stages.

In some implementations, the predetermined number of streams of dry tailings material is determined according to a capacity of each one of the corresponding re-wetting stages.

In some implementations, the process further comprises combining the plurality of streams of re-wetted tailings material together to produce a re-wetted tailings material.

In some implementations, at least two of the corresponding re-wetting stages are performed in a re-wetting unit that comprises a rotating element comprising a shaft and projections extending outwardly therefrom.

In some implementations, the projections comprises baffles, blades and/or paddles configured to impart the mixing to the combined tailings material.

In some implementations, the rotating element is configured as an auger conveyor, and the projections are provided as an helicoidal projection extending around the shaft.

In some implementations, the re-wetting unit comprises a pugmill.

In some implementations, the dry tailings material has a dry tailings moisture content of less than 3 wt %.

In some implementations, the dry tailings material has a dry tailings moisture content of less than 1 wt %.

In some implementations, the wetting agent comprises an aqueous wetting agent.

In some implementations, the aqueous wetting agent comprises water recovered from a NAE solids dryer.

In some implementations, the aqueous wetting agent comprises water recovered from a mine site.

In some implementations, the aqueous wetting agent comprises process-affected water from an oil sands mining facilities.

In some implementations, the aqueous wetting agent comprises mature fine tailings.

In some implementations, the aqueous wetting agent comprises fluid fine tailings.

In some implementations, the aqueous wetting agent comprises froth treatment tailings.

In some implementations, the wetting agent comprises a wetting agent additive.

In some implementations, the wetting agent additive comprises a non-ionic surfactant.

In some implementations, the wetting agent additive comprises an anionic surfactant.

In some implementations, the wetting agent comprises steam.

In some implementations, the re-wetted tailings material is suitable for deposition in a permanent storage area.

In accordance with another aspect, there is provided a non-aqueous extraction (NAE) process for producing a hydrocarbon product, comprising:
treating a feedstock to produce the hydrocarbon product and a dry tailings material;
contacting a main stream of the dry tailings material with a re-wetted tailings seed stream to produce a combined tailings material; and
subjecting the combined tailings material to re-wetting to produce a re-wetted tailings material, comprising:
   adding a wetting agent to the combined tailings material; and
   imparting mixing to the combined tailings material.

### BRIEF DESCRIPTION OF THE DRAWINGS

FIG. 1 is a block diagram of an example of a non-aqueous extraction process for extracting bitumen from oil sands.

FIG. 2 is a block diagram of a process for treating solvent diluted tailings from a non-aqueous extraction process to produce a re-wetted tailings material, the process including a drying stage and a re-wetting stage.

FIG. 3 is a block diagram of a process for conditioning a dry tailings material to produce a re-wetted tailings material, the process including a re-wetting stage.

FIG. 4 is a block diagram of a process for conditioning a dry tailings material to produce a re-wetted tailings material, the process including a re-wetting stage and a sub-stream re-wetting stage.

FIG. 5 is a block diagram of a process for treating solvent diluted tailings from a non-aqueous extraction process to produce a re-wetted tailings material, the process including a drying stage and a plurality of re-wetting stages.

FIG. 6 is a block diagram of a process for treating solvent diluted tailings from a non-aqueous extraction process to produce a re-wetted tailings material, the process including a plurality of drying stages and a plurality of re-wetting stages.

FIG. 7 is a schematic diagram of the process shown in FIG. 3, with the re-wetting stage being performed in a rotary drum.

FIG. 8 is a schematic diagram of the process shown in FIG. 4, with the sub-stream re-wetting stage being performed in a pugmill and the re-wetting stage being performed in a rotary drum.

FIG. 9 is a schematic diagram of the process shown in FIG. 3, with the re-wetting stage being performed in a rotary drum and a conveyor.

FIG. 10 is a schematic diagram of the process shown in FIG. 4, with the re-wetting stage being performed in a rotary drum and a conveyor.

### DETAILED DESCRIPTION

Techniques described herein relate to processes and systems for conditioning a dry tailings material produced as part of a NAE process for extracting bitumen from oil sands ore. The dry tailings are produced following solvent recovery from solvent diluted tailings that have been separated from diluted bitumen during an extraction stage. Dry tailings from a NAE process include very fine dust particles, e.g., clay fines from the ore, and can be characterized by their low moisture content and their hydrophobicity. These characteristics can give rise to various challenges such as dust formation and poor geotechnical properties of the dry tailings. These characteristics of the dry tailings can also impair their suitability for deposition into a permanent storage area.

In order to overcome at least some of these challenges, the conditioning of the dry tailings material can be aimed at increasing the moisture content of the dry tailings material and overcoming the hydrophobicity of the dry tailings material. Various implementations are described herein to achieve such objectives, and generally include re-wetting the dry tailings material by adding a wetting agent, such as water, to the dry tailings material to produce a re-wetted tailings material.

To facilitate incorporation of the wetting agent to the dry tailings material, avoid formation of cohesive lumps and re-wet the dry tailings more uniformly, the process for conditioning the dry tailings material can include contacting a main stream of the dry tailings material with a re-wetted tailings seed stream to produce a combined tailings material, and subjecting the combined tailings material to re-wetting to produce a re-wetted tailings material. The re-wetting can include adding a wetting agent to the combined tailings material and imparting mixing to the combined tailings material. The re-wetted tailings seed stream is a stream of dry tailings that has an increased moisture content compared to the main stream of dry tailings material such that when combined with the main stream of dry tailings material, the moisture content of the main stream of dry tailings is also increased. In some implementations, the moisture content of the combined tailings material can be at or above the moisture content that overcomes the hydrophobicity of the dry tailings.

The re-wetted tailings seed stream can come from various sources. For instance, the re-wetted tailings seed stream can be a recycle stream from the re-wetted tailings material. The re-wetted tailings seed stream can also be produced by a distinct re-wetting stage and in dedicated equipment chosen such that the resulting re-wetted tailings seed stream has a desired moisture content.

Another strategy for conditioning the dry tailings material can involve the use of a series of re-wetting equipment, or re-wetting units, operated in parallel to perform corresponding re-wetting stages on a predetermined number of streams of dry tailings material to produce a plurality of streams of re-wetted tailings material. This type of strategy can enable treating large volumes of dry tailings that can be generated during a NAE process while taking advantage of the re-wetting performance of the equipment chosen to be operated in parallel for performing the corresponding re-wetting stages.

### General Overview of a Non-Aqueous Extraction Process

A general overview of a NAE process will now be described in the following paragraphs.

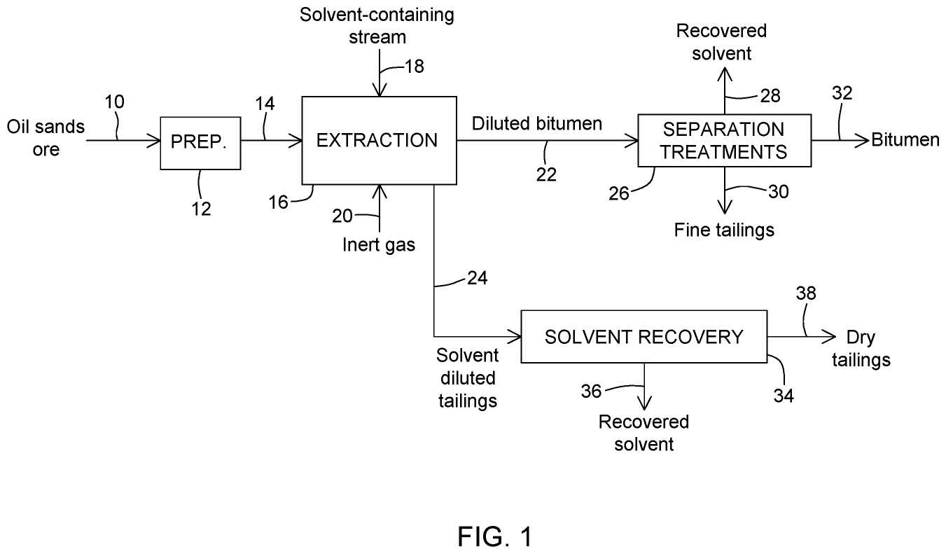

Referring to FIG. 1, a NAE process can include subjecting mined oil sands ore 10 that includes bitumen, mineral solids and naturally occurring water to a preparation stage 12 prior to subsequent extraction of bitumen. The preparation 12 can include crushing, sizing, and pre-treating to produce a sized ore material 14 that can be introduced into a non-aqueous extraction stage 16 where a hydrocarbon solvent facilitates extraction of the bitumen from the mineral solids that make up the oil sands ore. The extraction stage 16 can be an integrated stage that enables multiple features including ablation of the ore, digestion of the ore, extraction of the bitumen from the mineral solids, and separation of the solvent and bitumen from the mineral solids. In some implementations, this extraction stage 16 can be implemented in a single unit, although in other implementations, multiple distinct units can be used to perform certain operations associated with the extraction stage, such as ablation, digestion, extraction and separation.

A solvent-containing stream 18 is supplied to the extraction stage 16 to dilute the bitumen and promote extraction and separation of the bitumen from the mineral solids. The solvent-containing stream 18 includes a hydrocarbon solvent that can be selected to be more volatile than the bitumen to facilitate downstream separation and recovery of the solvent. In some implementations, the solvent-containing stream 18 includes a paraffinic solvent that has good solubility for bitumen extraction and allows easy separation from the bitumen after extraction. Paraffinic solvents, which can also be referred to as aliphatic solvents, have relatively low boiling points compared to aromatic and naphthenic compounds with identical carbon numbers and have a lower tendency to keep fine inorganic solids such as clays suspended. Therefore, a NAE process that uses paraffinic solvents can facilitate the production of relatively clean diluted bitumen with low contents of inorganic solids and water. Inorganic solids are mainly present as sand, silt and clay in oil sands ore and the streams derived from oil sands.

An inert gas 20 is also delivered to the extraction stage 16 and associated units to displace any oxygen or maintain pressure to prevent in-leakage.

The extraction stage 16 produces solvent diluted bitumen 22 and solvent diluted tailings 24, which can be also referred to as solvent diluted coarse tailings. The solvent diluted bitumen 22 is subjected to additional separation treatments 26 including solvent recovery to obtain recovered solvent 28 that can be reused in the NAE process, fine tailings 30 that are composed mainly of fine particular mineral solids less than 44 microns as well as residual solvent and bitumen, and bitumen 32. The bitumen 32 can include some solvent and residual contaminants, and can be subjected to further processing, such as deasphalting and refining.

Still referring to FIG. 1, the solvent diluted tailings 24 are subjected to a drying stage 34, or solvent recovery stage, to produce recovered solvent 36 and dry tailings 38, which can also be referred to as solvent depleted tailings or dry tailings material. In some implementations, removing solvent from the solvent diluted tailings 24 can include washing the solvent diluted tailings 24 with a solvent wash to produce a solvent wash liquor and a washed solvent affected tailings material. The washed solvent affected tailings material can be draining to produce solvent drainage and a drained solvent affected tailings material. The drained solvent affected tailings material can then be subjected to drying by evaporating solvent contained therein.

The drying stage 34 can be performed for instance in a solvent recovery unit. Various types of tailings solvent recovery units and methods can be used, including drying with direct or indirect heating in a drum dryer, steam or inert gas stripping, and/or microwave-based separation. One or more types of dryers can be operated in series or parallel, as will be explained in further detail below. It is to be noted that various techniques other than the one described above can be implemented to obtain the dry tailings 38 from the solvent diluted tailings 24 produced by the extraction stage 16, and that the dry tailings described herein as a starting material for being subjected to re-wetting can be produced by any of these techniques.

The drying step produces dry tailings 38 and recovered solvent 36. The dry tailings 38 includes very low residual bitumen and solvent. In some implementations, the dry tailings 38 can include both coarse and fine mineral solids that have been combined upstream in the process, or the dry tailings 38 can include either coarse mineral solids or fine mineral solids that have been generated separately. The dry tailings 38 are typically transported by solids handling means for disposal (e.g., within a mine pit), or can be further processed, for instance to recover valuable minerals or other non-hydrocarbon components that may be present therein, or to remove additional bitumen or solvent within another processing unit. In the context of the present description, the dry tailings 38 can be transported by solids handling means to be subjected to conditioning.

### Conditioning of a Dry Tailings Material

In the context of the present description, the dry tailings 38 from the NAE process are subjected to conditioning to increase the moisture content of the dry tailings 38 and produce a re-wetted tailings material. The re-wetted tailings material that is produced according to the techniques described herein can be suitable for transportation and for deposition in a dedicated area for permanent storage, such as a mine pit. Re-wetting a dry tailings material from a NAE process can contribute to providing various benefits, such as cooling the dry tailings material to improve handling safety and reduce the temperature at which they are deposited, reducing or suppressing dust generation, improving geotechnical properties including trafficability and compacted density, and creating a water-wet substrate for the reclaimed landforms.

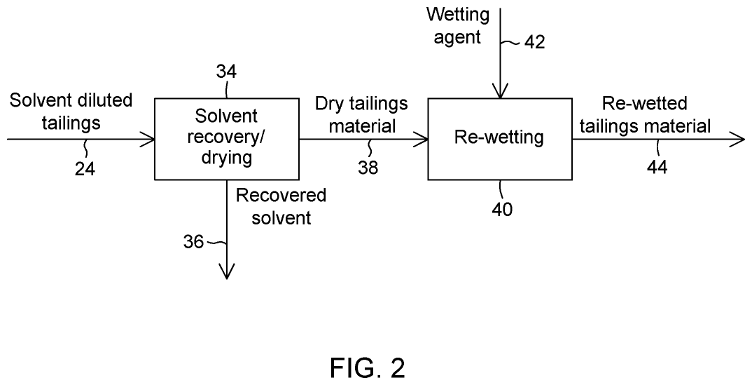

Referring to FIG. 2, a general process for conditioning a dry tailings material to increase the moisture content of the dry tailings 38 and produce a re-wetted tailings material is shown. As mentioned above, the dry tailings material 38 is obtainable from a NAE extraction process, and more particularly from a drying stage 34 that receives solvent diluted tailings 24 and produces a recovered solvent 36 as vapour and the dry tailings material 38. It is to be noted that “solvent recovery stage” and “drying stage” are expressions that can be used interchangeably to designate the process step that produces the dry tailings material 38.

The drying stage 34 can be considered as an evaporative drying stage, and accordingly, the drying stage 34 can be performed at a temperature that is sufficient to enable evaporation of solvent from the solvent diluted tailings 24. Accordingly, in some implementations, the dry tailings material 38 discharged from the drying stage 34 can be at a temperature ranging from about 80° C. to about 160° C.

The dry tailings material 38 can have various levels of moisture content, depending for instance on the type of unit used to perform the drying stage 34, or on the characteristics of the tailings that are produced by the extraction stage 16. Thus, when referring to dry tailings herein, it is meant to refer to any tailings from a NAE process that have a sufficiently low moisture content to benefit from an increase in moisture content in order to facilitate subsequent operations performed on the re-wetted tailings material. In other words, the techniques described herein provide an approach for the handling of dry tailings that can advantageously contribute to overcoming at least in part challenges associated with the re-wetting of dry tailings given the hydrophobicity of this material, irrespective of the initial moisture content of the dry tailings material. Examples of moisture content of the dry tailings are given for illustrative purposes only, and should not be considered limitative. In some implementations, the moisture content of the dry tailings material 38 can range from less than about 15 wt %, less than about 10 wt %, less than about 7 wt %, less than about 3 wt %, less than about 2 wt %, or less than about 1 wt %.

The dry tailings material 38 is then conditioned to increase its moisture content. The conditioning includes subjecting the dry tailings material 38 to a re-wetting stage 40. The re-wetting stage 40 involves the addition of a wetting agent 42 to the dry tailings material 38, and produces a re-wetted tailings material 44.

The wetting agent 42 can be any aqueous fluid that enables increasing the moisture content of the dry tailings material 38. Examples of such aqueous fluid can include water recovered from the drying stage 34, water recovered from the mine site, such as precipitation and run-off water, deposit water, and basal water, process-affected water from other oil sands mining facilities, river water, and tailings fluids from other oil sands mining sites such as mature fine tailings, fluid fine tailings and froth treatment tailings. Regarding the water that can be recovered from the drying stage 34, this water can originate from connate water present in the mined oil sands ore or from surface waters (e.g., rain, snow, ice) incidentally introduced in the course of oil sands mining operations. In some implementations, connate water can typically represent about 4 wt % to 5 wt % of the mined oil sands ore. Any other aqueous fluid that can contribute to increasing the moisture content of the dry tailings material 38 can also be suitable.

When the wetting agent 42 comprises an aqueous fluid, the addition of the wetting agent can contribute to reducing the temperature of the dry tailings material being subjected to re-wetting, and thus can provide cooling to the hot dry tailings material coming from the dryer. For instance, in some implementations, the addition of the wetting agent can reduce the temperature of the dry tailings material being subjected to re-wetting to below 80° C.

In some implementations, the wetting agent 42 can be introduced to the re-wetting stage 40 as steam, with the steam condensing upon contact with the dry tailings material 38 to provide the aqueous fluid to re-wet the dry tailings. The contacting of steam with the dry tailings material can also be combined with another wetting agent to improve re-wetting performance. The use of steam as a wetting agent can enable intimate contact between the water and the dry tailings, even when the dry tailings are hydrophobic. An element to take into consideration when using steam as a wetting agent is that given that the enthalpy of steam condensation is substantial, small quantities of moisture addition can increase the temperature of the tailings to an undesirable level, which may reach the boiling point of water. Accordingly, when steam is used as a wetting agent, a cooling system for reducing the temperature of the dry tailings being subjected to re-wetting can be implemented to beneficiate from the re-wetting potential of steam while overcoming the increase in temperature of the tailings associated with the use of steam.

In some implementations, the wetting agent 42 can include a wetting agent additive that can promote re-wetting of the dry tailings material 38 compared to when an aqueous fluid alone is used as the re-wetting agent. Such wetting agent additives can have various properties, including enabling a reduction of the interfacial tension between the water and mineral solids, thereby reducing the time or shear required to wet the dry solids. Examples of wetting agent additives include non-ionic surfactants and anionic surfactants.

The re-wetting stage 40 can be performed in various types of re-wetting units that enable contacting the dry tailings material 38 with the wetting agent 42 to produce the re-wetted tailings material 44. Given the hydrophobicity of the dry tailings material 38, the re-wetting unit can be chosen so as to impart sufficient mixing or shear to overcome the interfacial resistance of the dry tailings material 38 and for the wetting agent 42 to penetrate into the bulk of the dry tailings material 38.

In some implementations, the re-wetting stage 40 can be performed in a rotary drum. The blending action of the rotary drum can typically impart less shear than other types of mixing units. As a result, the initial incorporation of the wetting agent 42 into the dry tailings material 38 may occur slowly, which can lead to a lingering presence of a free water phase that may undesirably lead to operational issues, such as water running through the drum. Another consideration is that as the wetting agent eventually incorporates into the tailings, cohesive tailings clumps tend to form while leaving the remainder of the tailings dry. This cohesive behaviour is due at least in part to capillary forces between wet clay particles. With continued tumbling, these cohesive tailings clumps gradually break down and distribute their moisture through the tailings, although the final moisture distribution of the re-wetted tailings material may still be variable. Nonetheless, a rotary drum can provide benefits when it comes to the re-wetting of dry tailings from a NAE process such as its simplicity of use, its capacity to treat large volumes of dry tailings, and its physical robustness. Various strategies can be implemented to increase the performance of a rotary drum as a re-wetting unit, such as increasing vessel size, increasing residence time, increasing the rotational speed, optimizing the design of the internals of the rotary drum (e.g., lifters), and optimizing the wetting agent distribution system that introduces the wetting agent 42 into the rotary drum.

In some implementations, the re-wetting stage 40 can be performed in a pugmill, also referred to as a paddle mixer, or in multiple pugmills arranged in parallel, as will be described in more detail below. A pugmill includes one or more rotating elements that are received into a trough. Each rotation element includes a shaft and projections extending outwardly from the shaft. The projections can include baffles, blades and/or paddles that are configured to provide shear energy to the dry tailings material and to advance solids downstream along the trough. In some implementations, the rotating element can be configured as an auger, and the projections can be provided as an helicoidal projection extending around the shaft. One of the challenges related to the use of a pugmill for re-wetting dry tailings from a NAE process is that the projections can be exposed to substantial wear given the abrasive nature of solids that can be present in the dry tailings material 38. To address this challenge, the projections can be made of a high wear material such as High Chrome White Iron (HCWI), Chrome White Iron (CWI), chrome carbide or sintered tungsten carbide, which can contribute to increasing the lifespan of the projections. The projections can also be made of a base metal overlaid with a wear-resistant material such as chromium carbide, boron carbide or tungsten carbide. Another challenge related to the use of a pugmill for re-wetting dry tailings from a NAE process is that the volume capacity of this type of equipment may not be sufficient to handle the large volumes of dry tailings that are produced during the NAE process. However, the re-wetting performance of a pugmill makes it a candidate of choice for integration into a process for re-wetting dry tailings from a NAE process, such as the processes further described below.

In addition to the rotary drum and the pugmill described above as examples of equipment that can be used as re-wetting units, several other types of mixers can be used for re-wetting the dry tailings material 38, such as fluidized beds and pin mixers, and any of these mixers can be implemented for the processes described herein.

In some implementations, the drying stage 34 and the re-wetting stage 40 can be performed in an integrated unit. For instance, an upstream section of the integrated unit can be configured to perform the drying stage 34, and a downstream section of the integrated unit can be configured to perform the re-wetting stage 40. An example of equipment that can be configured or designed to perform both the drying stage 34 and the re-wetting stage 40 can be a rotary drum.

In some implementations, the dry tailings material 38 can include residual solvent from the extraction stage 16. Accordingly, the re-wetting stage 40 can be configured for replacing interstitial oxygen in the dry tailings material 38 with an inert gas to reduce the oxygen concentration and limit the ingress of oxygen to the re-wetting stage 40, which in turn can prevent flammable conditions within the re-wetting stage 40. The inerting gas can be any type of gas, such as but limited to, nitrogen and natural gas. The re-wetting stage 40 can also be configured to create and maintain a positive pressure environment to keep preventing air ingress and maintain a low oxygen environment.

### Process Implementations for Conditioning a Dry Tailings Material

Various process implementations of a process for conditioning a dry tailings material and produce a re-wetted tailings material will now be described in further detail.

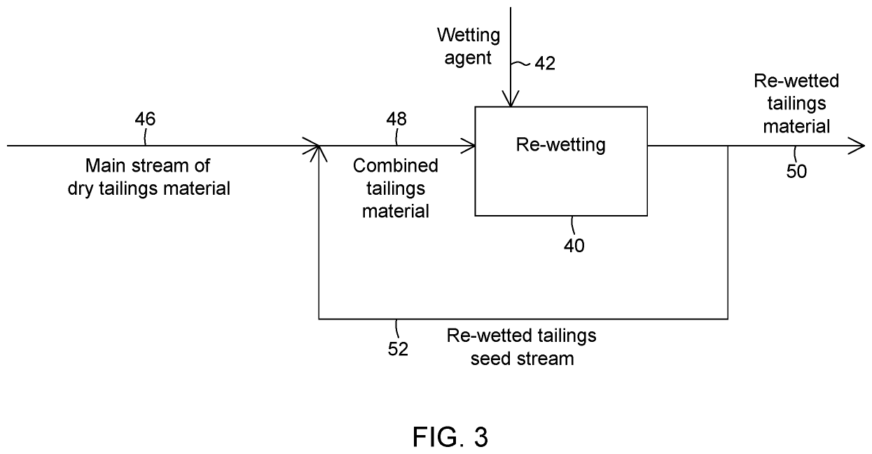

As conventional uses of standalone equipment as re-wetting units for re-wetting a main stream of dry tailings material from a NAE process for extracting bitumen from oil sands ore can give rise to certain challenges in terms of re-wetting performance, improvements to such conventional uses have been developed and are described herein. In general terms, one such improvement can include contacting a main stream of the dry tailings material with a re-wetted tailings seed stream to produce a combined tailings material, and then subjecting the combined tailings material to re-wetting to produce a re-wetted tailings material. Examples of this concept is illustrated in FIGS. 3, 4, and 7-10, although other configurations are also possible.

### Recycling of a Re-Wetted Tailings Material

Referring to 3, a main stream 46 of a dry tailings material 38 is initially supplied to a re-wetting stage 40 as described above with reference to FIG. 2. During an initial phase of the process, the re-wetting stage 40 produces a partially re-wetted tailings material. As used herein for describing the implementation shown in FIG. 3, the expression “initial phase” refers to a phase of the process that occurs when the process is initially implemented, which can be for instance before reaching a steady state of the process. The initial phase of the process can also be referred to as a startup phase.

The partially re-wetted material is a tailings material that has a higher moisture content compared to the moisture content of the main stream 46 of dry tailings material. However, in some implementations and depending on the equipment used for performing the re-wetting stage 40 and on the stage of the conditioning process, the partially re-wetted material produced during the initial phase of the conditioning process can have some of the characteristics of the tailings material described above in relation with the operation of a rotary drum for re-wetting dry tailings. For instance, the partially re-wetted tailings material may be unevenly re-wetted, and can include cohesive tailings clumps that are dispersed in the remainder of dry tailings.

In order to address these challenges and still during the initial phase of the process, a portion, or substantially all, of the partially re-wetted tailings material can be recycled back to the main stream 46 of the dry tailings material 38 and be combined therewith to form a combined tailings material 48. Since the partially re-wetted tailings material has a higher moisture content compared to the moisture content of the main stream 46 of the dry tailings material 38, the recycling of a portion, or substantially all, of the partially re-wetted tailings material to the main stream 46 of the dry tailings material 38 can enable increasing the moisture content of the main stream 46 of the dry tailings material 38 with the formation of the combined tailings material 48. The combined tailings material 48 thus has a higher moisture content compared to the main stream 46 of the dry tailings material 38, but a lower moisture content compared to the partially re-wetted tailings material.

In implementations where substantially all of the partially re-wetted tailings material is recycled back to be combined with the main stream 46 of the dry tailings material 38, it is to be understood that this option can be implemented during the initial stage of the conditioning process for instance when the characteristics of the partially re-wetted tailings material are deemed unsatisfactory for subsequent processing steps. For example, if the re-wetting stage 40 produces a partially re-wetted tailings material having a moisture content that is so low that the partially re-wetted tailings material has similar characteristics as the main stream 46 of the dry tailings material 38 for instance in terms of dust formation, then it may be beneficial to recycle substantially all of the partially re-wetted tailings material back to be combined with the main stream 46 of the dry tailings material 38 so that it can be subjected again to the re-wetting stage 40.

The cycle that includes subjecting the combined tailings material 48 to the re-wetting stage 40 and recycling a portion of the partially re-wetted tailings material back to the main stream 46 of the dry tailings material 38 can be repeated for a number of times that enables providing sufficient mixing to the combined tailings material 48 in the re-wetting stage 40. Repetitively passing of the portion of the partially re-wetted tailings material through the re-wetting stage 40 so that the combined tailings material 48 can be subjected to re-wetting and mixing via the recycling to the main stream 46 of the dry tailings 38 can facilitate breakdown of the cohesive clumps and production of a partially re-wetted material that progressively tends to be increasingly more homogeneously re-wetted. The number of cycles can thus be increased to increase the overall residence time of the partially re-wetted tailings material in the equipment into which is performed the re-wetting stage 40, such that the partially re-wetted material eventually becomes a re-wetted tailings material having desired characteristics, for instance in terms of moisture content, overall moisture distribution, and absence of cohesive lumps.

In some implementations, the cycle of subjecting the combined tailings material 48 to the re-wetting stage 40 and recycling of the portion of the partially re-wetted tailings material can be repeated until the combined tailings material at least reaches a predetermined moisture content. In some implementations, the predetermined moisture content of the combined tailings material can be a moisture content that has been determined as being at or above a moisture content threshold. The moisture content threshold can correspond to the threshold above which the dry tailings (which are now in the form of a combined tailings material) become hydrophilic, i.e., a moisture content threshold that can overcome the hydrophobicity of the dry tailings. Examples of a moisture content threshold for dry tailings that are produced by a NAE process can be for instance between about 2 wt % and about 4 wt %, or between about 3 wt % and 5 wt %. It is important to note, however, that the moisture content threshold above which the dry tailings become hydrophilic can vary depending on factors such as the mineral characteristics of the dry tailings material, e.g., the clay content of the dry tailings material, the grain size of the dry tailings material, the residual organic solvent or bitumen content of the dry tailings material, and the degree to which the fine particles have agglomerated.

Another strategy for producing a re-wetted tailings material during an initial phase of the conditioning process is to adjust the operating parameters of the re-wetting stage 40 such that the re-wetting stage 40 produces a re-wetted tailings material 50 that has desired characteristics, which as mentioned above can include for instance a moisture content, an overall moisture distribution, and an absence of cohesive lumps. In such implementations, the cycle that includes subjecting the combined tailings material 48 to the re-wetting stage 40 and recycling a portion of the partially re-wetted tailings material back to the main stream 46 of the dry tailings material 38 can be omitted, or can nonetheless be performed if determined to be a suitable approach to achieve the desired characteristics of the re-wetted tailings material. Examples of operating parameters of the re-wetting stage 40 that can be adjusted to produce a re-wetted tailings material 50 having desired characteristics can include the residence time in the equipment performing the re-wetting stage 40, the amount of wetting agent added to the main stream 46 of dry tailings 38, the rotating speed of the drum or of the mixing paddle shafts, and the equipment fill fraction.

In such implementations, the operating parameters of the re-wetting stage 40 can be adjusted such that when the re-wetted tailings material 50 is combined with the main stream 46 of the dry tailings material 38, the combined tailings material at least reaches a predetermined moisture content. As mentioned above, the predetermined moisture content can be a moisture content that has been determined as being at or above a moisture content threshold, the moisture content threshold corresponding to the threshold above which the dry tailings become hydrophilic. Examples of a moisture content threshold for dry tailings that are produced by a NAE process can be for instance between about 2 wt % and 4 wt %.

Another factor that can be modulated to produce a combined tailings material 48 having a predetermined moisture content of the combined tailings material, or at least a desired moisture content of the combined tailings material, is the ratio at which the partially re-wetted tailings material or the re-wetted tailings material 50 is combined with the main stream 46 of the dry tailings material 38. In some implementations, the weight ratio at which the partially re-wetted tailings material or the re-wetted tailings material 50 is combined with the main stream 46 of the dry tailings material 38 can range between 1:1 to 1:10. This ratio can vary throughout the duration of the initial phase of the conditioning process, for instance as the partially re-wetted tailings material becomes more evenly re-wetted and mixes more uniformly with the main stream 46 of the dry tailings material 38.

In some implementations, the determination of the ratio at which the partially re-wetted tailings material or the re-wetted tailings material 50 is combined with the main stream 46 of the dry tailings material 38 can be performed based on the monitoring of the moisture content of the combined tailings material 48. In other words, the moisture content of the combined tailings material 48 can be monitored to obtain a monitored combined tailings moisture content of the combined tailings material 48, and depending on whether the monitored combined tailings moisture content is above or below the moisture content threshold of the dry tailings material, the proportion of the partially re-wetted tailings material or of the re-wetted tailings material 50 relative to the main stream 46 of the dry tailings material 38 can be increased or decreased.

For instance, if it is determined that the monitored combined tailings moisture content of the combined tailings material is above the moisture content threshold of the dry tailings material, the ratio of the partially re-wetted tailings material or of the re-wetted tailings material 50 relative to the main stream 46 of the dry tailings material 38 can be reduced, as the combined tailings material has reached a moisture content that can enable overcoming the hydrophobicity of the combined tailings material. Reducing the ratio of the partially re-wetted tailings material or of the re-wetted tailings material 50 relative to the main stream 46 of the dry tailings material 38 can involve for instance increasing the flow rate of the main stream 46 of the dry tailings 38, and/or reducing the flow rate of the partially re-wetted tailings material or of the re-wetted tailings material 50.

On the other hand, if it is determined that the monitored combined tailings moisture content of the combined tailings material is below the moisture content threshold of the dry tailings material, the ratio of the partially re-wetted tailings material or of the re-wetted tailings material 50 relative to the main stream 46 of the dry tailings material 38 can be increased, as the combined tailings material has a moisture content that may be insufficient for overcoming the hydrophobicity of the combined tailings material. Increasing the ratio of the partially re-wetted tailings material or of the re-wetted tailings material 50 relative to the main stream 46 of the dry tailings material 38 can involve for instance reducing the flow rate of the main stream 46 of the dry tailings 38, and/or increasing the flow rate of the partially re-wetted tailings material or of the re-wetted tailings material 50.

Once it is determined that the partially re-wetted tailings material or of the re-wetted tailings material 50 has desired characteristics to enable the combined tailings material to reach a predetermined moisture content, such as a predetermined moisture content that can correspond to a moisture content threshold above which the dry tailings become hydrophilic, the initial phase of the conditioning process of the dry tailings can be considered as being terminated, and the portion of the partially re-wetted tailings material or of the re-wetted tailings material 50 that is recycled back to the main stream 46 of the dry tailings material 38 can be referred to as a re-wetted tailings seed stream 52, as shown in FIG. 3.

The re-wetted tailings seed stream 52 thus corresponds to a stream of dry tailings that have been re-wetted to reach a given moisture content and that is combined at a given ratio with the main stream 46 of the dry tailings material 38 so as to produce a combined tailings material 48 that has a predetermined moisture content that is above a moisture content threshold above which the dry tailings become hydrophilic. This phase of the conditioning process following the initial phase can be referred to as an operating phase, which may or may not be operated under steady state conditions.

Still referring to FIG. 3, during the operating phase of the conditioning process for conditioning a dry tailings material and produce a re-wetted tailings material, a main stream 46 of a dry tailings material 38 is combined with a re-wetted tailings seed stream 52 to produce the combined tailings material 48. As mentioned above, the main stream 46 of a dry tailings material 38 can be any dry tailings from a NAE process that have a sufficiently low moisture content to benefit from an increase in moisture content in order to facilitate subsequent operations performed on the re-wetted tailings material. In some implementations, the dry tailings material 38 is hydrophobic.

In some implementations, the moisture content of the dry tailings material 38 can range from less than about 15 wt %, less than about 10 wt %, less than about 7 wt %, less than about 3 wt %, less than about 2 wt %, or less than about 1 wt %.

In some implementations, the re-wetted tailings seed stream can have for instance a seed stream moisture content above 6 wt %, above 7 wt %, above 8 wt %, above 9 wt %, above 10 wt %, above 12 wt %, above 15 wt %, or between 6 wt % and 15 wt %.

The characteristics of the re-wetted tailings seed stream 52 can be such that once combined with the main stream 46 of the dry tailings material 38, the combined tailings material 48 has a predetermined moisture content, i.e., a predetermined combined tailings moisture content. In some implementations, the predetermined moisture content of the combined tailings material can be a moisture content that corresponds to, or that is above, a moisture content threshold above which the dry tailings become hydrophilic. In some implementations, the combined tailings material 48 can have a combined tailings moisture content above 2 wt %, between 2 wt % and 4 wt %, between 3 wt % and 5 wt %, between 3 wt % and 15 wt %, between 5 wt % and 12 wt %, between 6 wt % and 10 wt %, or between 6 wt % and 15 wt %.

In some implementations, the moisture content of the combined tailings material 48 can be expressed as an increase in moisture content relative to the moisture content of the main stream 46 of the dry tailings material 38. For instance, the combined tailings material 48 can have a combined tailings moisture that is between 2 to 10 times a dry tailings moisture content of the main stream 46 of the dry tailings material 38, or the combined tailings material 48 can have a combined tailings moisture that is at least 5 times a dry tailings moisture content of the main stream 46 of the dry tailings material 38.

Furthermore, the re-wetted tailings seed stream can be provided at a weight ratio relative to the main stream of the dry tailings material that enables reaching a predetermined combined tailings moisture content for the combined tailings material. In some implementations, the re-wetted tailings seed stream can be provided at a weight ratio ranging between 1:1 to 1:6 relative to the main stream of the dry tailings material to produce the combined tailings material.

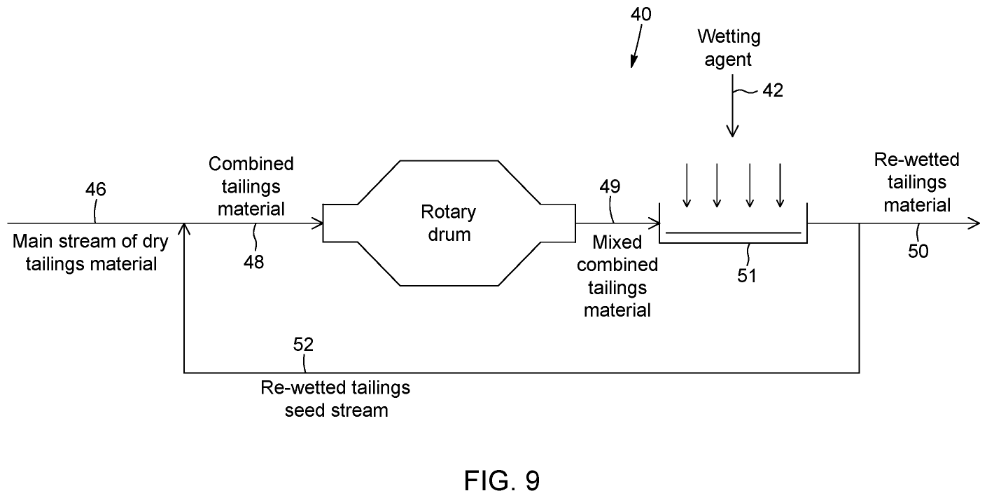

With reference to FIG. 9, in some implementations, the re-wetting stage 40 can include imparting mixing to the combined tailings material 48, followed by the addition of a wetting agent 42 to the combined tailings material 48 that has been subjected to mixing, prior to the recycling of the re-wetted tailings seed stream 52 to the main stream 46 of the dry tailings material 38. In other words, in such implementations, the mixing of the combined tailings material 48 can be performed in a given equipment to produce a mixed combined tailings material 49, while the addition of the wetting agent 42 can be performed downstream in a distinct equipment to re-wet the mixed combined tailings material 49. In such implementations, the mixing of the combined tailings material 48 can be performed for instance in a rotary drum, and the mixed combined tailings material 49 that has been subjected to mixing can then be supplied to a conveyor having an overhead spray to spray the wetting agent 42 onto the mixed combined tailings material 49 to produce a re-wetted tailings material 50 and the wetted tailings seed stream 52 that will be combined with the main stream 46 of the dry tailings material 38.

In some implementations, the process can include supplying the re-wetted tailings material to a conveyor and spraying an additional wetting agent onto the re-wetted tailings material to further increase a re-wetted tailings material moisture content of the re-wetted tailings material.

When the re-wetting stage 40 is performed in a rotary drum as a re-wetting unit, the wetting agent 42 can be added at various locations along the longitudinal axis of the rotary drum. For instance, in some implementations, the addition of the wetting agent 42 can be done at a downstream end of the re-wetting unit, or at an upstream end of the re-wetting unit. Alternatively, the wetting agent 42 can be introduced to the rotary at multiple locations along the longitudinal axis of the rotary drum.

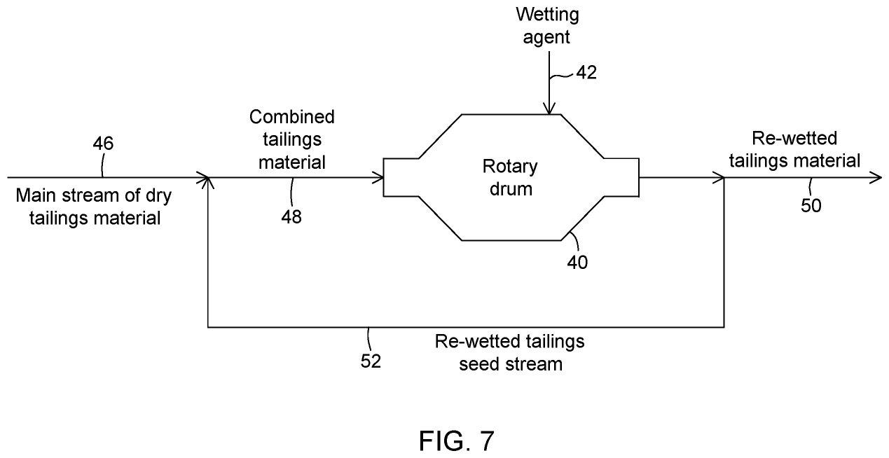

FIG. 7 illustrates an implementation where the re-wetting stage 40 is performed in a rotary drum as a re-wetting unit.

### Sub-Stream Re-Wetting

Another example of a process for conditioning a dry tailings material and produce a re-wetted tailings material using a re-wetted tailings seed stream will now be described.

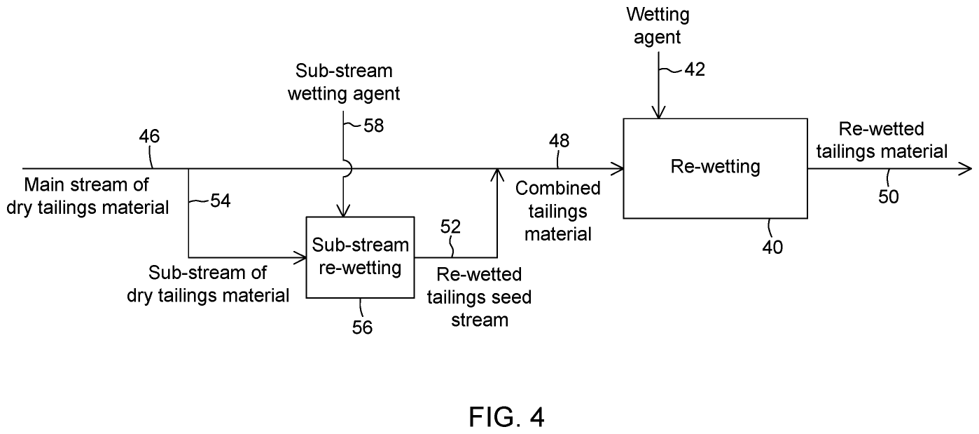

Referring to FIG. 4, a portion of a main stream 46 of a dry tailings material 38 is diverted to a sub-stream re-wetting stage 56 that is configured to produce a re-wetted tailings seed stream 52. The portion of the main stream 46 of the dry tailings material 38 that is diverted to the sub-stream re-wetting stage 56 can be referred to as a sub-stream 54 of dry tailings material 38. In some implementations, the moisture content of the dry tailings material 38, and thus of the sub-stream 54 of the dry tailings material 38, can range from less than about 15 wt %, less than about 10 wt %, less than about 7 wt %, less than about 3 wt %, less than about 2 wt %, or less than about 1 wt %.

The sub-stream re-wetting stage 56 can be performed in various types of sub-stream re-wetting units that enable contacting the sub-stream 54 of dry tailings material 38 with a sub-stream wetting agent 58 to produce the re-wetted tailings seed stream 52. Given the hydrophobicity of the dry tailings material 38, the equipment dedicated to performing the sub-stream re-wetting stage 56 can be chosen so as to impart sufficient mixing or shear to overcome the interfacial resistance of the dry tailings material 38 and for the sub-stream wetting agent 58 to penetrate into the bulk of the sub-stream 54 of the dry tailings material 38.

In some implementations, performing the sub-stream re-wetting stage 56 can include imparting a rotational movement to the sub-stream 54 of the dry tailings material 38 and the sub-stream wetting agent 58 via a rotation of a rotation element comprising a shaft and projections extending outwardly therefrom. Such rotational movement can be achieved for instance in a pugmill as described above. Given that conventional pugmills may typically have a volume capacity that may not be sufficient to perform re-wetting of large volumes of dry tailings produced during an NAE process, the configuration of the conditioning process shown in FIG. 4 can still take advantage of the performance of such equipment for re-wetting a dry tailings material, albeit on a sub-stream 54 of the dry tailings material 38, and thus on a smaller volume of the dry tailings material 38. It is to be understood that other types of equipment can also be used to perform the sub-stream re-wetting stage 56, such as a rotary drum, a fluidized bed or a pin mixer.

The operating parameters of the sub-stream re-wetting stage 56 can be adjusted such that the re-wetted tailings seed stream 52 has desired characteristics, for instance in terms of moisture content. In some implementations, the re-wetted tailings seed stream 52 can have a seed stream moisture content above 6 wt %, above 7 wt %, above 8 wt %, above 9 wt %, above 10 wt %, above 12 wt %, above 15 wt %, or between 6 wt % and 15 wt %.

The operating parameters of the sub-stream re-wetting stage 56 can also be adjusted such that when the re-wetted tailings seed stream 52 produced by the sub-stream re-wetting stage 56 is combined with the main stream 46 of the dry tailings material 38, the combined tailings material 48 at least reaches a predetermined moisture content. The predetermined moisture content can be a moisture content that has been determined as being at or above a moisture content threshold, the moisture content threshold corresponding to the threshold above which the dry tailings become hydrophilic. Examples of a moisture content threshold for dry tailings that are produced by a NAE process can be for instance between about 2 wt % and 4 wt %. Examples of operating parameters of the sub-stream re-wetting stage 56 that can be adjusted to produce the re-wetted tailings seed stream 52 can include the residence time in the equipment performing sub-stream re-wetting stage 56, and the amount of sub-stream wetting agent 58 added to the sub-stream 54 of the dry tailings material 38.

As described above, the ratio at which the re-wetted tailings seed stream 52 is combined with the main stream 46 of the dry tailings material 38 to produce the combined tailings material 48 can be modulated to achieve desired characteristics of the combined tailings material 48. In some implementations, the weight ratio at which the re-wetted tailings seed stream 52 is combined with the main stream 46 of the dry tailings material 38 can range between 1:1 to 1:10. The determination of the ratio at which the re-wetted tailings seed stream 52 is combined with the main stream 46 of the dry tailings material 38 can be performed based on the monitoring of the moisture content of the combined tailings material 48. In other words, the moisture content of the combined tailings material 48 can be monitored to obtain a monitored combined tailings moisture content of the combined tailings material 48, and depending on whether the monitored combined tailings moisture content is above or below the moisture content threshold of the dry tailings material, the proportion of the re-wetted tailings seed stream 52 relative to the main stream 46 of the dry tailings material 38 can be increased or decreased.

For example, if it is determined that the monitored combined tailings moisture content of the combined tailings material 48 is above the moisture content threshold of the dry tailings material 38, the ratio of the re-wetted tailings seed stream 52 relative to the main stream 46 of the dry tailings material 38 can be reduced, as the combined tailings material has reached a moisture content that can enable overcoming the hydrophobicity of the combined tailings material 48. Reducing the ratio of the re-wetted tailings seed stream 52 relative to the main stream 46 of the dry tailings material 38 can involve for instance increasing the flow rate of the main stream 46 of the dry tailings 38, and/or reducing the flow rate of the re-wetted tailings seed stream 52.

Alternatively, if it is determined that the monitored combined tailings moisture content of the combined tailings material 48 is below the moisture content threshold of the dry tailings material 38, the ratio of the re-wetted tailings seed stream 52 relative to the main stream 46 of the dry tailings material 38 can be increased, as the combined tailings material 48 has a moisture content that may be insufficient for overcoming the hydrophobicity of the combined tailings material 48. Increasing the ratio of the re-wetted tailings seed stream 52 relative to the main stream 46 of the dry tailings material 38 can involve for instance reducing the flow rate of the main stream 46 of the dry tailings 38, and/or increasing the flow rate of the re-wetted tailings seed stream 52.

The re-wetted tailings seed stream 52 can be provided at a weight ratio relative to the main stream 46 of the dry tailings material 38 that enables reaching a predetermined combined tailings moisture content for the combined tailings material 48. In some implementations, the re-wetted tailings seed stream 52 can be provided at a weight ratio ranging between 1:1 to 1:6 relative to the main stream 46 of the dry tailings material 38 to produce the combined tailings material 48.

In some implementations, the combined tailings material 48 can have a combined tailings moisture content above 2 wt %, between 2 wt % and 4 wt %, between 3 wt % and 5 wt %, between 3 wt % and 15 wt %, between 5 wt % and 12 wt %, between 6 wt % and 10 wt %, or between 6 wt % and 15 wt %.

The combined tailings material 48 can subsequently be subjected to a re-wetting stage 40. The re-wetting stage 40 can include adding a wetting agent 42 to the combined tailings material 48, and imparting mixing to the combined tailings material 48. The wetting agent 42 can be the same or be different than the sub-stream wetting agent 58.

As the combined tailings material 48 has reached a combined tailings moisture content that is above the moisture content threshold of the dry tailings material, subsequent re-wetting of the combined tailings material 48 can be facilitated. Accordingly, the combined tailings material 48 can be subjected to the re-wetting stage 40 in an equipment that when used as a standalone equipment to subject dry tailings to re-wetting without prior combination with a re-wetted tailings seed stream may lead to operational upsets due to the lingering presence of a free water phase, and produce a tailings material that includes cohesive tailings clumps and that has a variable moisture distribution.

Furthermore, as subsequent re-wetting of the combined tailings material 48 is facilitated due to the combined tailings moisture content that is above the moisture content threshold of the dry tailings material, a larger volume of the combined tailings material 48 can be supplied to the re-wetting stage 40 while maintaining the performance of the equipment to produce the re-wetted tailings material 50 having desired characteristics in terms of moisture content and uniformity of moisture distribution.

An example of an equipment that can be used to perform the re-wetting stage 40 following combination of the re-wetted tailings seed stream 52 with the main stream 46 of the dry tailings material 38 is a rotary drum.

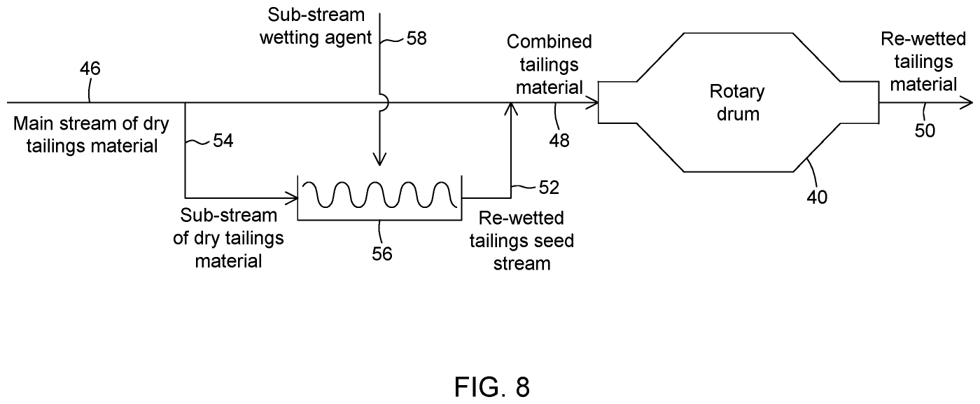

FIG. 8 illustrates an implementation where the sub-stream re-wetting stage 56 is performed in a pugmill as a sub-stream re-wetting unit, and the re-wetting stage 40 is performed in a rotary drum as a re-wetting unit.

In some implementations, since the performance of the re-wetting stage 40 can be increased with the production of the combined tailings material 48 that has a combined tailings moisture content above the moisture content threshold of the dry tailings material, the size of the equipment used for performing the re-wetting stage 40 can be reduced, and associated operating and capital cost for re-wetting the dry tailings material can also be reduced.

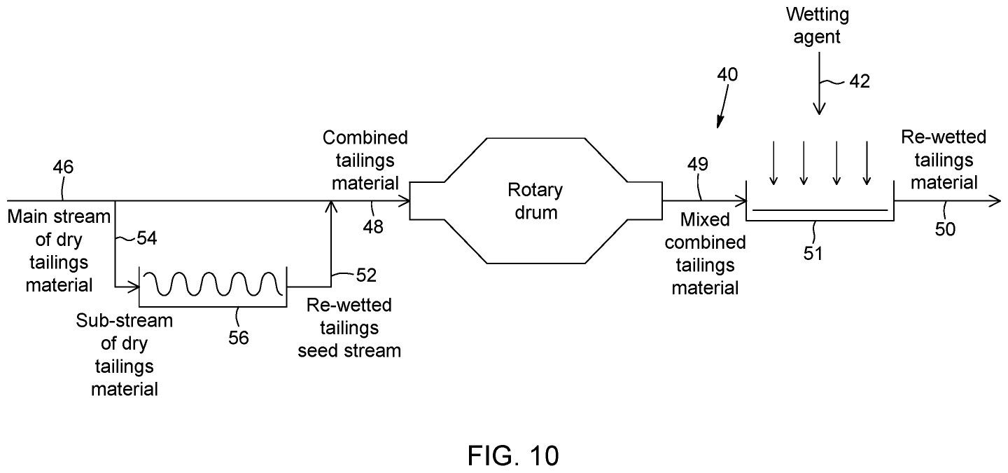

Referring to FIG. 10, in some implementations, the re-wetting stage 40 can include imparting mixing to the combined tailings material 48 to produce a mixed combined tailings material 49, followed by the addition of a wetting agent 42 to the mixed combined tailings material 49. In such implementations, the mixing of the combined tailings material 48 can be performed for instance in a rotary drum, and the mixed combined tailings material 49 can then be supplied to a conveyor 51 having an overhead spray to spray the wetting agent 42 onto the combined tailings material 48 that has been subjected to mixing to produce a re-wetted tailings material 50. This configuration of the re-wetting stage 40 can be beneficial for instance to provide good quality mixing between the main stream 46 of dry tailings material 38 and the re-wetted tailings seed stream 52, and then to tailor the addition of the wetting agent 42 to the mixed combined tailings material 49 thereafter.

### Re-Wetting Stage Performed in Parallel

A process for drying solvent diluted tailings and subjecting a plurality of streams of dry tailings material to corresponding re-wetting stages will now be described.

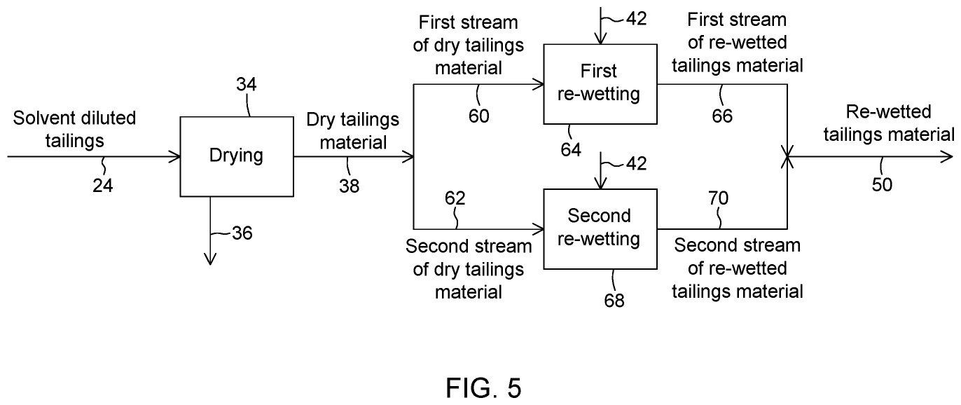

With reference to FIG. 5, the solvent diluted tailings 24 from the extraction stage 16 are subjected to a drying stage 34 to produce recovered solvent 36 and a dry tailings material 38. In some implementations, the moisture content of the dry tailings material 38 can range from less than about 15 wt %, less than about 10 wt %, less than about 7 wt %, less than about 3 wt %, less than about 2 wt %, or less than about 1 wt %.

The dry tailings material 38 from the drying stage 34 is then divided into a predetermined number of streams of dry tailings material 38 that are each subsequently subjected to a corresponding re-wetting stage, the corresponding re-wetting stages being provided according to a parallel configuration.

The predetermined number of streams of dry tailings material 38 can be established in accordance with the overall volume of the dry tailings material 38 that is produced by the drying stage 34 and the individual volume capacity of the equipment used for performing the corresponding re-wetting stages 40. For example, if the drying stage 34 produces approximately 2000 tons per hour (tph) of dry tailings and the capacity of the equipment chosen to perform the re-wetting stage 40 is of approximately 500 tph, it can be determined that the dry tailings material 38 from the drying stage 34 can be divided into four streams of dry tailings material 38 of approximately 500 tph each such that each equipment performing the corresponding re-wetting stage 40 can have the potential to be used accordingly to its full capacity if desired. It is to be noted that the example presented above is for illustrative purposes only, to exemplify the concept of having a dry tailings material 38 from the drying stage 34 that is divided into a predetermined number of streams of dry tailings material 38 that are each subsequently subjected to a corresponding re-wetting stage 40.

In FIG. 5, a dry tailings material 38 from the drying stage 34 is divided into a first stream of dry tailings material 60 and a second stream of dry tailings material 62. The predetermined number of streams of dry tailings material 38 thus corresponds to two streams of dry tailings material 38. The first stream of dry tailings material 60 is subjected to a corresponding first re-wetting stage 64 to produce a first stream of re-wetted tailings material 66. The second stream of dry tailings material 62 is subjected to a corresponding second re-wetting stage 68 to produce a second stream of re-wetted tailings material 70. In this illustrated implementation, the flow rate of dry tailings material 38 produced by the drying stage 34 and the capacity of the equipment chosen to perform the corresponding re-wetting stages are variables that have been used to determine the number of streams that the dry tailings material 38 was divided into.

Following the first re-wetting stage 64 and the second re-wetting stage 68, the first stream of re-wetted tailings material 66 and the second stream of re-wetted tailings material 70 can remain as distinct streams and be further treated or disposed of as such in a common or respective deposition structure or deposition area. Alternatively, the first stream of re-wetted tailings material 66 and the second stream of re-wetted tailings material 70 can be combined to form a re-wetted tailings material 50 that can also be either further treated or permanently stored in a deposition structure or a deposition area.

In these implementations, the predetermined number of streams of dry tailings material 38 and the associated number of corresponding re-wetting stages provided in a parallel configuration can be increased to a number as high as desired depending on the volume of the dry tailings material produced by the drying stage 34 and the capacity of the equipment chosen to perform the corresponding re-wetting stages.

This configuration can provide several benefits, such as taking advantage of the re-wetting performance of a given equipment for re-wetting dry tailings from a NAE process that as a standalone equipment may not typically be sized to receive high volumes of dry tailings that can be produced by a NAE process. By providing a series of such equipment in parallel, re-wetting performance can thus be increased while conditioning a large volume of dry tailings.

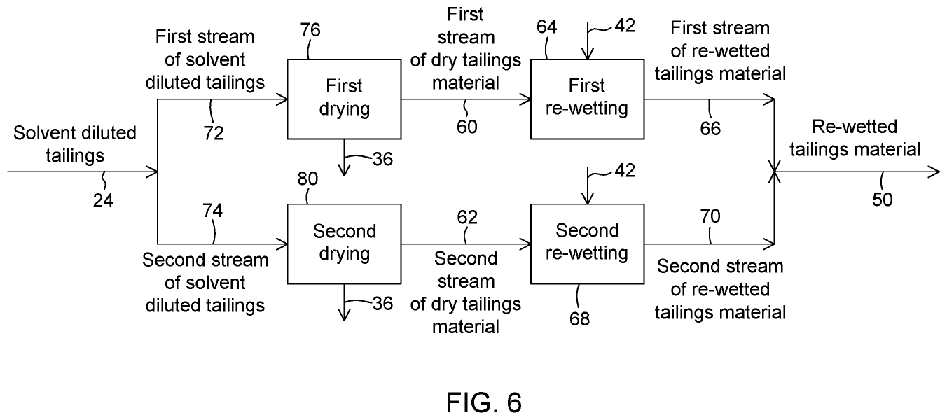

FIG. 6 illustrates an alternative implementation to the configuration presented in FIG. 5. In this implementation, each one of the re-wetting stages is associated with a corresponding drying stage. The number of re-wetting stages can also be determined according to the overall volume of dry tailings that is expected to be produced based on the solvent diluted tailings 24 to be treated, and on the volume capacity of the equipment chosen to perform the re-wetting stages. Once the number of re-wetting stages is determined, each of the re-wetted stage can be attributed a corresponding drying stage that will produce a stream of dry tailings that will serve as a feedstock for the re-wetting stage. It is to be understood that there can also be two or more re-wetting stages that can be associated with a single drying stage, as illustrated in FIG. 5, and that this configuration can be replicated so as to have more than one drying stage.

In FIG. 6, the solvent diluted tailings 24 from the extraction stage 16 are divided into a first stream of solvent diluted tailings 72 and a second stream of solvent diluted tailings 74. The first stream of solvent diluted tailings 72 is supplied to a first drying stage 76 to produce a first stream of dry tailings material 60. The second stream of solvent diluted tailings 74 is supplied to a second drying stage 80 to produce a second stream of dry tailings material 62.

The first stream of dry tailings material 60 and the second stream of dry tailings material 62 described with reference to FIG. 6 can be considered as being similar to the first stream of dry tailings material 60 and the second stream of dry tailings material 62 described above with reference to FIG. 5, as each of these streams of dry tailings material are then subsequently subjected to a corresponding re-wetting stage. More particularly, the first stream of dry tailings material 60 is supplied to a first re-wetting stage 64 to produce a first stream of re-wetted tailings material 66, and the second stream of dry tailings material 60 is supplied to a second re-wetting stage 68 to produce a second stream of re-wetted tailings material 70. As mentioned above, the first stream of re-wetted tailings material 66 and the second stream of re-wetted tailings material 70 can remain as distinct streams and be further treated or disposed of as such in a common or respective deposition structure or deposition area. Alternatively, the first stream of re-wetted tailings material 66 and the second stream of re-wetted tailings material 70 can be combined to form a re-wetted tailings material 50 that can also be either further treated or permanently stored in a deposition structure or deposition area.

An example of equipment, or apparatus, that can be used to perform the corresponding re-wetting stages in parallel as shown in FIGS. 5 and 6 is one configured for imparting a rotational movement to the dry tailings material and the wetting agent via a rotation of a rotation element comprising a shaft and projections extending outwardly therefrom. An example of such equipment is a pugmill, or paddle mixer, as described above. Thus, in some implementations, the first, second, and so on, re-wetting stages can be performed in a series of pugmills provided in parallel. Each of the pugmills can be configured to receive a wetting agent 42 that is added to the dry tailings material, and to produce a re-wetted tailings material 50 having a desired moisture content such that the re-wetted tailings material can be suitable for further processing or for permanent storage in a dedicated deposition structure or area.

In some implementations, the corresponding re-wetting stages can be operated to produce streams of re-wetted tailings material having a moisture content ranging from 3 wt % to 15 wt %, or above 15 wt %, depending on the characteristics of the dry tailings material being subjected to re-wetting, including the initial moisture content of the dry tailings material.

### Handling of Re-Wetted Tailings Material

As briefly discussed above, the re-wetted tailings material 50 produced by the re-wetting stage 40 can have suitable characteristics to enable permanent storage thereof in a deposition structure or deposition area, which may include above-grade external deposits or below-grade deposits in a mined-out pit, for instance. The re-wetting of the dry tailings in accordance with the techniques described above can improve their geotechnical properties, enabling the deposits to be constructed with steeper slope angles and higher densities compared if the dry tailings were deposited without being re-wetted. These deposits can then be reclaimed and closed as terrestrial landforms, though there may also be end-pit lake-type deposits depending on the quantity of water remaining at end of mine life.

Regarding transportation of the re-wetted tailings material, mine equipment and processes readily available can be used. For instance, high capacity trucks can be used for transporting the re-wetted tailings material from the processing facility to the deposit. These trucks may be human-operated, remote operated, or autonomous. Alternate ore transport options, including long distance conveyor systems, can also be used.

Special tailings handling strategies can be developed for re-wetted tailings that are considered as being “off specification”, i.e., re-wetted tailings having at least one property that lies outside of a predetermined specification for such re-wetted tailings. Examples of re-wetted tailings that can be considered as being “off specification” can include re-wetted tailings having an elevated solvent content, an elevated bitumen content or an elevated water content, a low water content, an elevated temperature, or a mineral composition (e.g., clay content) or a characteristic (e.g., particle size) that is outside of a specified range.

A system can be used for measuring or inferring when the re-wetted tailings are “off specification”. Such system can include the use of “virtual sensors”, i.e., algorithms that can infer re-wetted tailings properties for which it may not be feasible to obtain direct online measurements using data from other sensors. For instance, a dryer bed temperature profile can be used to predict a residual solvent content in the re-wetted tailings, or a density of the solvent diluted bitumen from the extraction stage can be used to predict a residual bitumen content in re-wetted tailings. Other measuring instruments including hydrocarbon vapour sensors can also be employed.

If re-wetted tailings are detected as being “off specification”, additional measures for handling the re-wetted tailings can be implemented. For instance, the operating parameters of the conditioning process can be adjusted prior to the discharge of the re-wetted tailings from the plant. The “off specification” tailings can be re-processed in dedicated equipment tailored for such “off specification” processing. The re-wetted tailings can also be diverted to intermediate holding areas to allow certain off-spec parameters time to naturally return to acceptable levels, such as solvent content and temperature. Yet another option for handling re-wetted tailings that are “off specification” is to send such tailings to a dedicated area in the deposit for off-spec materials.

It is to be noted that the techniques described herein can also be applicable to other industrial processes that involve mixing liquids into solids such as fly ash conditioning, cement mixing and mineral agglomeration.

Several alternative implementations and examples have been described and illustrated herein. The implementations of the technology described above are intended to be exemplary only. A person of ordinary skill in the art would appreciate the features of the individual implementations, and the possible combinations and variations of the components. A person of ordinary skill in the art would further appreciate that any of the implementations could be provided in any combination with the other implementations disclosed herein. It is understood that the technology may be embodied in other specific forms without departing from the central characteristics thereof. The present implementations and examples, therefore, are to be considered in all respects as illustrative and not restrictive, and the technology is not to be limited to the details given herein. Accordingly, while the specific implementations have been illustrated and described, numerous modifications come to mind.

1. A process for conditioning a dry tailings material from a non-aqueous extraction (NAE) process for extracting bitumen from oil sands ore, the process comprising:
contacting a main stream of the dry tailings material with a re-wetted tailings seed stream to produce a combined tailings material; and
subjecting the combined tailings material to re-wetting to produce a re-wetted tailings material, comprising:
adding a wetting agent to the combined tailings material; and
imparting mixing to the combined tailings material.

2. The process of claim 1, wherein contacting the main stream of the dry tailings material with the re-wetted tailings seed stream comprises:
recycling a portion of the re-wetted tailings material to the main stream of the dry tailings material as the re-wetted tailings seed stream to produce the combined tailings material.

3. The process of claim 1, wherein subjecting the combined tailings material to re-wetting is performed in a re-wetting unit that comprises a rotary drum.

4. The process of claim 1, wherein imparting mixing to the combined tailings material is performed prior to adding the wetting agent to the combined tailings material.

5. The process of claim 1, wherein adding the wetting agent to the combined tailings material comprises supplying the wetting agent to the combined tailings material travelling onto a conveyor.

6. The process of claim 5, wherein supplying the wetting agent to the combined tailings material travelling onto the conveyor comprises spraying the wetting agent onto the combined tailings material via an overhead spray.

7. The process of claim 1, wherein contacting the main stream of the dry tailings material with the re-wetted tailings seed stream comprises:
subjecting a sub-stream of the dry tailings material to sub-stream re-wetting in a sub-stream re-wetting unit to produce the re-wetted tailings seed stream.

8. The process of claim 7, wherein the sub-stream re-wetting unit comprises a rotating element comprising a shaft and projections extending outwardly therefrom.

9. The process of claim 8, wherein the projections comprises baffles, blades and/or paddles configured to impart the mixing to the combined tailings material.

10. The process of claim 1, wherein adding the wetting agent to the combined tailings material comprises supplying the wetting agent to the combined tailings material travelling onto a conveyor.

11. The process of claim 10, wherein supplying the wetting agent to the combined tailings material travelling onto the conveyor comprises spraying the wetting agent onto the combined tailings material via an overhead spray.

12. The process of claim 1, wherein the dry tailings material has a dry tailings moisture content of less than 3 wt %.

13. The process of claim 1, wherein the re-wetted tailings seed stream has a seed stream moisture content above 6 wt %.

14. The process of claim 1, wherein the combined tailings material has a combined tailings moisture content above 2 wt %.

15. The process of claim 1, wherein the wetting agent comprises an aqueous wetting agent.

16. The process of claim 1, wherein the wetting agent comprises a wetting agent additive.

17. The process of claim 16, wherein the wetting agent additive comprises a non-ionic surfactant.

18. The process of claim 16, wherein the wetting agent additive comprises an anionic surfactant.

19. The process of claim 1, wherein the re-wetted tailings material is suitable for deposition in a permanent storage area.

20. A process for conditioning a dry tailings material from a non-aqueous extraction (NAE) process for extracting bitumen from oil sands ore, the process comprising:
subjecting a sub-stream of the dry tailings material to re-wetting to produce a re-wetted sub-stream, comprising:
combining the sub-stream of the dry tailings material with a sub-stream wetting agent;
combining the re-wetted sub-stream with a main stream of the dry tailings material to produce a combined tailings material; and
subjecting the combined tailings material to re-wetting to produce a re-wetted tailings material, comprising:
combining the combined tailings material with a main stream wetting agent.

21. A non-aqueous extraction (NAE) process for producing a hydrocarbon product, comprising:
treating a feedstock to produce the hydrocarbon product and a dry tailings material;
contacting a main stream of the dry tailings material with a re-wetted tailings seed stream to produce a combined tailings material; and
subjecting the combined tailings material to re-wetting to produce a re-wetted tailings material, comprising:
adding a wetting agent to the combined tailings material; and
imparting mixing to the combined tailings material.
